(19) United States
(12) Patent Application Publication
(10) Pub. No.: US 2009/0290906 A1
(43) Pub. Date: Nov. 26, 2009

(54) Cartridges for Reprographics Devices

(75) Inventor: Russell Paul Cowburn, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: INGENIA HOLDINGS (UK) LIMITED, London (GB)

(21) Appl. No.: 12/471,215

(22) Filed: May 22, 2009

Related U.S. Application Data
(60) Provisional application No. 61/055,761, filed on May 23, 2008.

(30) Foreign Application Priority Data
May 23, 2008 (GB) 0809501.0

(51) Int. Cl. G03G 21/16; H04N 1/04

(52) U.S. Cl. 399/111; 358/474

(57) ABSTRACT

A removable cartridge for a reprographics device, such as a printer, is described. The removable cartridge comprises a signature scanning unit for use in generating a signature based upon an intrinsic characteristic of an article. By providing a signature scanning unit in a replaceable cartridge, few or no modifications to the existing designs of various reprographics devices are needed. Additionally, the installation of the signature scanning unit in a reprographics device is made as easy as replacing a standard removable cartridge, such as, for example, an inkjet or toner cartridge. The addition of authorisation/identification functionality to various conventional reprographics devices can also be made by a non-technical user using various embodiments of the invention.

### CROSS-REFERENCE TO RELATED APPLICATIONS

This application is based upon and claims the benefit of priority from the prior U.S. Patent Application No. 61/055,761, filed May 23, 2008, and prior GB Patent Application No. 0809501.0, filed May 23, 2008 both of which are hereby incorporated herein by reference in their entirety.

### FIELD

The present invention relates to removable cartridges for reprographics devices. In particular, it relates to removable cartridges that can be used in the process of identifying articles that may be used with reprographics devices. In one example, the reprographics device is a printer and the article is a sheet of paper that is passed through the printer.

The accurate and secure identification of various articles is known to be difficult. This is particularly so for articles that are produced with the aid of modern reprographics devices. Such articles may, for example, be produced either as individual “one-off” items (e.g. a passport, personal identification (ID) card, bill of lading, important document etc.) or in batches (e.g. postage stamps, limited edition prints, vendable products etc.) using, for example, reprographics devices such as printers, photocopiers, etc. Improvements in technology relating to reprographics devices have made it very much easier for forgers and counterfeiters to produce high quality copies of such articles.

To counter copying of various articles, many traditional authentication security systems rely on a process which is difficult for anybody other than the manufacturer to perform, where the difficulty may be imposed by expense of capital equipment, complexity of technical know-how or preferably both. Examples are the provision of a watermark in bank notes and a hologram on credit cards or passports. Unfortunately, criminals are becoming more sophisticated and can reproduce virtually anything that original manufacturers can do, particularly given continual rapidly advancing improvements in technology relating to reprographics devices, as referred to previously.

A known approach for authentication of articles relies on creating security tokens using some process governed by laws of nature which results in each token being unique, and more importantly having a unique characteristic that is measurable and can thus be used as a basis for subsequent verification. According to this approach tokens are manufactured and measured in a set way to obtain a unique characteristic. The characteristic can then be stored in a computer database, or otherwise retained. Tokens of this type can be embedded in the carrier article, e.g. a banknote, passport, ID card, important document. Subsequently, the embedded token in the carrier article can be measured again and the measured characteristic compared with the characteristics stored in the database to establish if there is a match.

Whilst conventional security tokens can be used to access information, authorise transactions etc., damaged tokens and imperfect token identification apparatuses can lead to difficulties in carrying out the activities to which the token should provide enablement.

The inventors have previously adopted various approaches when seeking to address the problems and disadvantages referred to above.

In one approach, the inventors applied a technique of using tokens made of magnetic materials for authentication, where the uniqueness is provided by unreproducible defects in the magnetic material that affect the token's magnetic response (as detailed in WO 2004/025548, Cowburn). As part of this work, magnetic materials were fabricated in barcode format, i.e. as a number of parallel strips.

As well as reading the unique magnetic response of the strips by sweeping a magnetic field with a magnetic reader, an optical scanner was built to read the barcodes by scanning a laser beam over the barcode and using contrast from the varying reflectivity of the barcode strips and the article on which they were formed. This information was complementary to the magnetic characteristic, since the barcode was being used to encode a digital signature of the unique magnetic response in a type of well known self authentication scheme (see for example, Kravolec “Plastic tag makes foolproof ID”, Technology research news, 2 Oct. 2002).

To the surprise of the inventor, it was discovered when using this optical scanner that the paper background material on which the magnetic chips were supported gave a unique optical response to the scanner. On further investigation, it was established that many other unprepared surfaces, such as surfaces of various types of cardboard and plastic, showed the same effect. Moreover, it has been established by the inventor that the unique characteristic arises at least in part from speckle, but also includes non-speckle contributions.

It has thus been discovered that it is possible to gain a unique digital signature for an article without having to use a specially prepared token, or specially prepare an article in any other way. In particular, many types of paper, cardboard and plastics have been found to give unique characteristic scattering signals from a coherent light beam, so that unique digital signatures can be obtained from almost any paper document or cardboard packaging item.

Previously known methods for obtaining a unique digital signature of an article (such as that described in WO 2007/072048, Cowburn) include inserting a removable cartridge, containing a scanning unit and controller, into the colour print cartridge holder of an inkjet printer. The controller in the cartridge may then be instructed to begin collecting data points for generating the signature of an area of an article when a printer driver sends predetermined print signals to the printer. For example, a signal instructing the printer to print a red dot might be used to instruct the controller to begin acquiring data points, and a signal instructing the printer to print a green dot might be used to instruct the controller to stop acquiring the data points. Thus use of existing printer software drivers can be used to activate and deactivate the collection of data points by the controller. The data points may then be processed to generate a unique digital signature.

Whilst collection of data points using existing printer software drivers is feasible in theory, in practice, different manufacturers use a variety of different printer software drivers to control the working of their printers. Therefore, in order for a removable cartridge, such as that described in WO 2007/072048, to be used with all available printers on the market, it would need to be compatible with each printer's corresponding printer software drivers. This poses a number of difficulties, as producing a removable cartridge which is compatible with all the printer software drivers available is an extremely complicated and time consuming process. Particularly, as printer manufactures spend large amounts of resources on generating software code and they are often reluctant to make the details easily available to the public. Hence, if the software is difficult to get access to, this makes the process of developing a removable cartridge which is compatible with the software an even greater challenge.

### SUMMARY

The present invention has been made, at least in part, in consideration of problems and drawbacks referred to herein.

Viewed from a first aspect, the present invention can provide a removable cartridge for a reprographics device. The removable cartridge can comprise a scanning unit operable to obtain a set of data points conveying information describing an intrinsic characteristic of an article and a controller operable to control the scanning unit to start obtaining the set of data points in response to detection of a predetermined printed pattern on an article.

Thus, the removable cartridge may be used with a variety of reprographics devices without needing to rely on existing printer software drivers to acquire a set of data points conveying information describing an intrinsic characteristic of an article. This is due to the collection of the data points by the controller being activated by recognition of a predetermined printed pattern on an article instead.

In various examples, the removable cartridge is configured to substitute for a removable printer cartridge in a printer. The removable printer cartridge may be an inkjet printer cartridge. For example, the inkjet printer cartridge may be a colour inkjet cartridge.

By providing a signature scanning unit in a replaceable cartridge, few or no modifications to the existing designs of various reprographics devices are needed. Additionally, the installation of the signature scanning unit in a reprographics device is made as easy as replacing a standard removable cartridge, such as, for example, an inkjet or toner cartridge. The addition of authorisation/identification functionality to various conventional reprographics devices can thus be retrofitted by a non-technical user using various embodiments of the invention.

The scanning unit may be operable to collect a set of data points from an article in a reading volume of the scanning unit. The scanning unit may include a source for generating a coherent beam, and a detector arrangement for collecting a set comprising groups of said data points from signals obtained when the coherent beam scatters from different parts of an article in the reading volume. Different ones of the groups of data points may relate to scatter from respective different parts of the article.

The detector arrangement may comprise a plurality of photodetectors. Each photodetector arranged to detect a respective signal obtained when the coherent beam scatters from different parts of the article in the reading volume. By using such a plurality of photodetectors, a larger number of unique articles can be recognised using a faster and more accurate recognition process. However, where a simplified low-cost signature scanning unit is needed, a single photodetector may be provided in the detector arrangement and still be operable to obtain sufficient data points to enable a signature to be determined.

The controller may be operable to stop obtaining data points after a predetermined time, predetermined distance or detection of a predetermined printed stop pattern.

The controller may include a processor for processing the data points to generate a signature. This enables a single removable cartridge to generate the data points and analyse them to determine the signature without relying on processing provided externally of the cartridge. Such cartridges simplify the use with the reprographics device. The cartridge may also include a communications interface for transmitting the signature from the controller to a database.

Other embodiments may require that the signature be derived by processing of the data points remotely from the cartridge. For example, the communications interface may transmit the data points from the controller to an external processor (such as a personal computer (PC) processor). The external processor may then generate the signature. The signature may then be transmitted to a database.

The communications interface may send information to the database or external processor via a wireless communication system, such as Bluetooth™ or WiFi™. Alternatively, the information may be transmitted over an existing communications channel connected to the reprographics device.

The removable cartridge may be powered by batteries or by the printer interface of the reprographics device.

Viewed from a second aspect, the present invention can provide a system for generating a signature. The system can include a removable cartridge including a scanning unit operable to obtain a set of data points conveying information describing an intrinsic characteristic of an article. The removable cartridge may also include a controller operable to control the scanning unit to start obtaining the set of data points in response to detection of a predetermined printed pattern on an article and a communications interface for transmitting the data points from the controller. The system may further include an external processor for receiving data points transmitted from the communications interface. The processor may be operable to generate a signature. The system may also include a database for receiving the signature from the external processor.

Thus the system described allows for the removable cartridge to acquire a set of data points describing an intrinsic characteristic of an article, and forward these to an external processor to generate the signature. The signature may then be stored in an external database. This system is advantageous as it can generate and store signatures which may be subsequently used to validate the authenticity of an article.

Viewed from a third aspect, the present invention can provide a system for generating a signature. The system may include a removable cartridge having a scanning unit operable to obtain a set of data points conveying information describing an intrinsic characteristic of an article. The removable cartridge may also include a controller operable to control the scanning unit to start obtaining the set of data points in response to detection of a predetermined printed pattern on an article. The controller may include a processor for processing the data points and generating a signature. The removable cartridge may also include a communications interface for transmitting the signature from the controller and the system may include a database for receiving the signature transmitted from the communications interface.

Thus, the system allows for the removable cartridge to acquire a set of data points describing an intrinsic characteristic of an article, generate a signature within the removable cartridge and store the signature in an external database. This system is advantageous because not only does it provide storage for a digital signature, which may be subsequently used to validate the authenticity of the article, it also eliminates the need to use an external processor for generating the signature.

Viewed from a fourth aspect, the present invention can provide a removable cartridge for a reprographics device. The removable cartridge can comprise means for obtaining a set of data points conveying information describing an intrinsic characteristic of an article. The removable cartridge can also comprise means for controlling the means for obtaining a set of data points to start obtaining the set of data points in response to detection of a predetermined printed pattern on an article.

Thus, the removable cartridge may be used with a variety of reprographics devices without needing to rely on existing printer software drivers to acquire a set of data points conveying information describing an intrinsic characteristic of an article.

Viewed from a fifth aspect, the present invention can provide a method for triggering collection of data points conveying information describing an intrinsic characteristic of an article. The method may comprise detecting a predetermined start pattern on an article received in a reading volume of a scanning unit and starting collection of the data points in response to the pattern.

The predetermined start pattern may be any of at least two or more vertical lines in parallel, a predetermined text pattern, or a logo.

The controller may stop collecting data points from the scanning unit after a predetermined time, predetermined distance or detection of a predetermined stop pattern. Such a predetermined stop pattern may be any of at least two or more vertical lines in parallel, a predetermined text pattern, logo, or a blank space.

Use of such predetermined start and stop patterns for acquiring data points for a signature provides a clear indication for where the signature is to be scanned on the article. The predetermined patterns also assist in identifying the area of the article to be subsequently scanned during the verification process in order to compare a verification signature to the previously stored signature.

In certain embodiments, the removable cartridge can also be operable to print on an article when the printer is operated. Such embodiments may be made by modifying conventional printer cartridges by adding a source/detector arrangement to provide additional signature scanning functionality.

### BRIEF DESCRIPTION OF THE FIGURES

Specific embodiments of the present invention will now be described by way of example only with reference to the accompanying figures in which:

FIG. 1 is a schematic view of a system for identifying an article from a signature based upon an intrinsic characteristic of the article;

FIG. 2 is a schematic view of a removable cartridge for a reprographics device in operation;

FIG. 3 is a schematic side view of an example of a scanning signature unit;

FIG. 4 is a schematic perspective view showing how the reading volume of the scanning signature unit of FIG. 3 is sampled;

FIG. 4A shows examples of predetermined start patterns;

FIG. 5 is a block schematic diagram of various functional components of the system of FIG. 1;

FIG. 6 is a schematic view of a reprographics device incorporating a scanning signature unit;

FIG. 7 is a schematic view of another example of a reprographics device incorporating a scanning signature unit;

FIG. 8A shows schematically in side view an alternative imaging arrangement for a scanning signature unit based on directional light collection and blanket illumination;

FIG. 8B shows schematically in plan view the optical footprint of a further alternative imaging arrangement for a scanning signature unit in which directional detectors are used in combination with localised illumination with an elongate beam;

FIG. 9A is a microscope image of a paper surface with the image covering an area of approximately 0.5×0.2 mm;

FIG. 9B is a microscope image of a plastic surface with the image covering an area of approximately 0.02×0.02 mm;

FIG. 10A shows raw data from a single photodetector using the scanning signature unit of FIG. 3 which consists of a photodetector signal and an encoder signal;

FIG. 10B shows the photodetector data of FIG. 10A after linearisation with the encoder signal and averaging the amplitude;

FIG. 10C shows the data of FIG. 10B after digitisation according to the average level;

FIG. 11 is a flow diagram showing how a signature of an article is generated from a scan;

FIG. 12 is a flow diagram showing how a signature of an article obtained from a scan can be verified against a signature database;

FIG. 13 is a flow diagram showing how the verification process of FIG. 12 can be altered to account for non-idealities in a scan;

FIG. 14A shows an example of cross-correlation data gathered from a scan;

FIG. 14B shows an example of cross-correlation data gathered from a scan where the scanned article is distorted;

FIG. 14C shows an example of cross-correlation data gathered from a scan where the scanned article is scanned at non-linear speed; and

FIG. 15 is a flow diagram showing the interaction between the scanner and controller to control the acquisition of data points.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DESCRIPTION OF PARTICULAR EMBODIMENTS

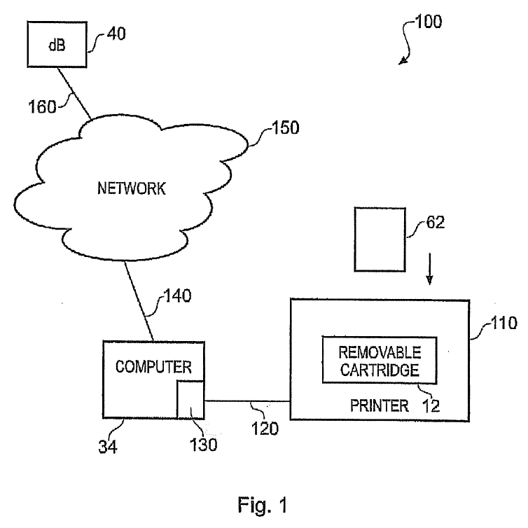

FIG. 1 is a schematic view of a system 100 for generating a signature based on a set of data points conveying information describing an intrinsic characteristic of an article 62.

The system 100 includes a computer system 34 connected via a network 150 to a remote database 40 for storing signatures. The network 150 may be the Internet, for example.

The computer system 34 also is connected to a reprographics device 110 through an interface 130. The reprographics device shown in FIG. 1 is a printer, however other reprographics devices, such as a plotter or other reciprocating head type recording machine, could also be utilised.

The printer 110 includes a removable cartridge 12 which may be inserted into an exiting print cartridge port within the printer. The removable cartridge 12 may be used to generate a signature from an article 62 as it is fed through the printer 110.

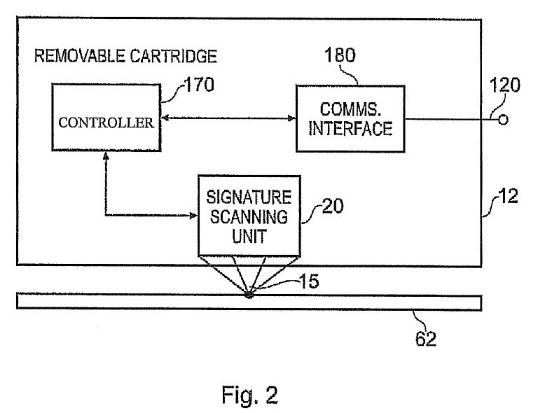

FIG. 2 shows a schematic view of a removable cartridge which is suitable for use with the printer 110.

The removable cartridge includes a signature scanning unit 20, a controller 170 for controlling the signature scanning unit 20 and a communications interface 180.

During operation of the reprographics device, the scanning unit 20 is operable to relay information to the controller 170 regarding the intrinsic characteristics of an article. The scanning unit 20 is also operable to relay information to the controller 170 regarding the details of the printed matter appearing on an article. This process is described in more detail further below.

The communications interface 180 is connected to the computer system interface 130 via a communications bus 120. The communications interface 180 provides a channel for data transfer between the removable cartridge 12 and the interface 130.

In embodiments where data and/or control signals are passed from the communications interface 180 to the interface 130 of the computer 34 via radio transmitter device, such as, a commercially available WiFi™ or Bluetooth™ transmitter/receiver, the communications bus 120 may not be needed.

The removable cartridge may be powered by batteries (not shown), or by the printer interface (not shown) of the reprographics device.

The removable cartridge 12 may be of the type that is described in European Patent Application number EP 1 029 685 modified to include a signature scanning unit 20 of the type described in greater detail below. The contents of EP 1 029 685 are hereby incorporated by reference into this specification in their entirety.

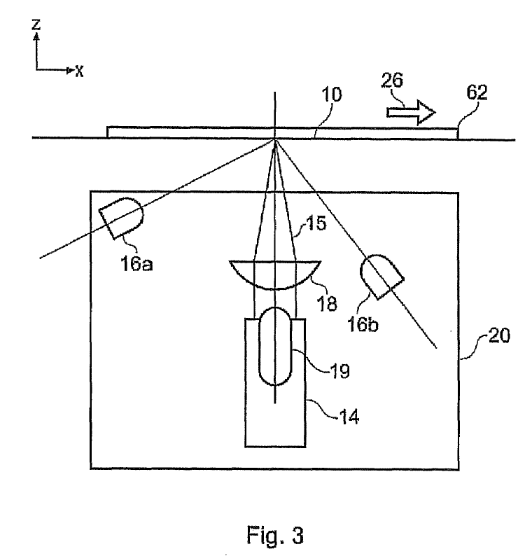

FIG. 3 shows a schematic side view of a first example of a signature scanning unit 20 which is suitable for use in the removable cartridge. The signature scanning unit 20 is for measuring a signature from an article 62 arranged in a reading volume of the apparatus. The reading volume is formed by a reading aperture 10 which is provided as a slit in a housing of the removable cartridge 12. The housing contains the main optical components of the signature scanning unit 20. The slit has its major extent in the x direction (see inset axes in the drawing). The principal optical components are a laser source 14 for generating a coherent laser beam 15 and a detector arrangement 16 made up of a plurality of k photodetector elements, where k=2 in this example, labelled 16a and 16b. The laser beam 15 is focused by a cylindrical lens 18 into an elongate focus extending in the y direction (perpendicular to the plane of the drawing) and lying in the plane of the reading aperture. In one example reader, the elongate focus has a major axis dimension of about 2 mm and a minor axis dimension of about 40 micrometres. These optical components are contained in a subassembly. In the present example, the four detector elements 16a and 16b are distributed either side of the beam axis offset at different angles in an interdigitated arrangement from the beam axis to collect light scattered in reflection from an article present in the reading volume. In the present example, the offset angles are −70 and +30 degrees. The angles either side of the beam axis are chosen so as not to be equal so that the data points they collect are as independent as possible. All four detector elements are arranged in a common plane. The photodetector elements 16a and 16b detect light scattered from an article placed on the housing when the coherent beam scatters from the reading volume. As illustrated, the source is mounted to direct the laser beam 15 with its beam axis in the z direction, so that it will strike an article in the reading aperture at normal incidence.

Generally it is desirable that the depth of focus is large, so that any differences in the article positioning in the z direction do not result in significant changes in the size of the beam in the plane of the reading aperture. In the present example, the depth of focus is approximately 0.5 mm which is sufficiently large to produce good results where the position of the article relative to the scanner can be controlled to some extent. The parameters, of depth of focus, numerical aperture and working distance are interdependent, resulting in a well known trade off between spot size and depth of focus.

A drive motor (not shown) of the printer 110 is arranged to providing linear motion of the article 62, as indicated by the arrow 26, within the reading volume. The drive motor thus serves to move the coherent beam relative to the article linearly in the x direction. Beam 15 thus scans the article 62 in a direction transverse to the major axis of the elongate focus. Since the coherent beam 15 is dimensioned at its focus to have a cross-section in the xz plane (plane of the drawing) that is much smaller than a projection of the reading volume in a plane normal to the coherent beam, i.e. in the plane of the housing wall in which the reading aperture is set, a scan of the drive motor will cause the coherent beam 15 to sample many different parts of the reading volume under action of the drive motor.

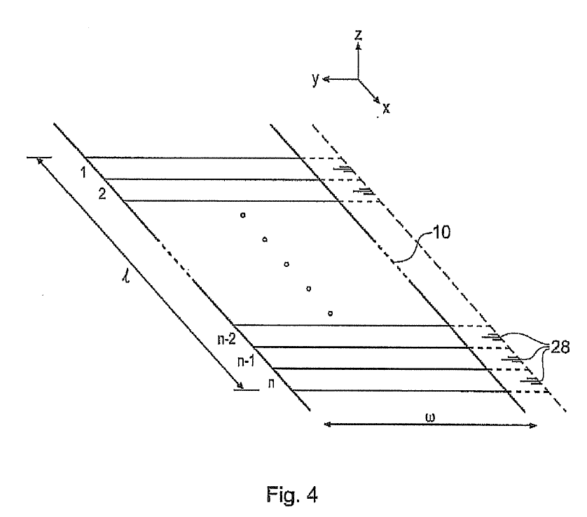

FIG. 4 is included to illustrate this sampling and is a schematic perspective view showing how the reading area is sampled n times by scanning an elongate beam across it. The sampling positions of the focused laser beam as it is scanned along the reading aperture under action of the drive is represented by the adjacent rectangles numbered 1 to n which sample an area of length ‘l’ and width ‘w’. Data collection is made so as to collect signal at each of the n positions as the drive is scanned along the slit. Consequently, a sequence of k×n data points are collected that relate to scatter from the n different illustrated parts of the reading volume.

Also illustrated schematically are optional distance marks 28 formed on the article 62 along the x direction, i.e. the scan direction. An example spacing between the marks in the x-direction is 300 micrometres. These marks are sampled by a tail of the elongate focus and provide for linearisation of the data in the x direction in situations where such linearisation is required, as is described in more detail further below. The measurement is performed by an additional phototransistor 19 which is a directional detector arranged to collect light from the area of the marks 28 adjacent the slit.

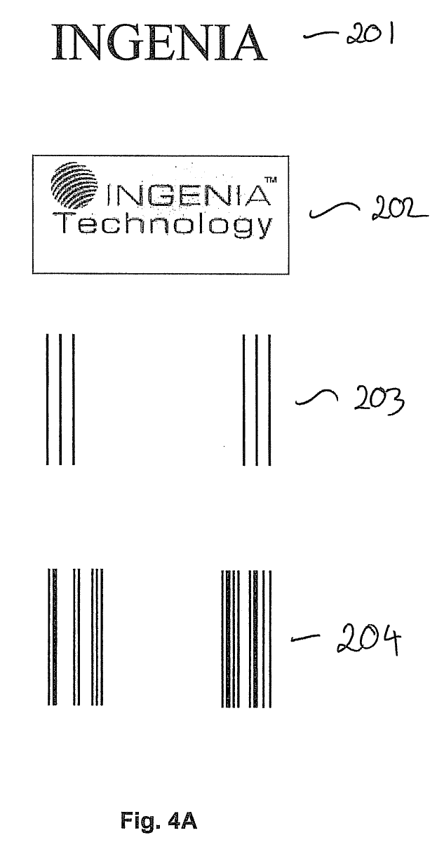

In alternative examples, the marks 28 can be read by a dedicated encoder emitter/detector module 19 that is part of the signature scanning unit 20. Encoder emitter/detector modules are used in bar code readers. In one example, an Agilent HEDS-1500 module that is based on a focused light emitting diode (LED) and photodetector can be used. The module signal is fed into the microcontroller ADC as an extra detector channel (see discussion of FIG. 5 below).

With an example minor dimension of the focus of 40 micrometers, and a scan length in the x direction of 2 cm, n=1000, giving 2000 data points with k=2. A typical range of values for k×n depending on desired security level, article type, number of detector channels ‘k’ and other factors is expected to be 100<k×n<10,000. It has also been found that increasing the number of detectors k also improves the insensitivity of the measurements to surface degradation of the article through handling, printing etc. In practice, with the prototypes used to date, a rule of thumb is that the total number of independent data points, i.e. k×n, should be 500 or more to give an acceptably high security level with a wide variety of surfaces. Other minima (either higher or lower) may apply where a scanner is intended for use with only one specific surface type or group of surface types.

An example of a type printer which could be suitable for use with the system described above includes an inkjet printer which uses a black ink cartridge and a colour ink cartridge. However, any reprographics device with ports suitable for accommodating removable cartridges as defined above may also be compatible for use.

When a user wishes to generate a signature for subsequent authentication of an article 62, the user may remove a colour print cartridge, for example, from the printer 110 and insert the removable cartridge 12.

An article 62, such as a sheet of paper, is inserted into the printer and the black print cartridge may begin printing on the article. A predetermined printed pattern, which is printed on the article 62 by the black print cartridge may be used to designate an area on the article to be scanned in order to generate a unique digital signature. Alternatively, pre-printed patterns on an article may also be used to designate an area to be scanned for generating the signature.

A selection of examples of predetermined printed patterns which may be used to designate an area on the article to be scanned are shown in FIG. 4a. A predetermined pattern is more easily identified by the scanner or an operator if it is an image that is easily distinguishable from other printed material commonly found on articles. Examples of distinguishable patterns include, a text pattern 201, a logo 202, or a plurality of vertical line arrangements 203, 204. However, those skilled in the art will appreciate that any distinctive printed pattern can be used to designate an area on the article to be scanned.

The controller 170 may include a processor (not shown) which processes the data points to derive the signature within the removable cartridge 12 itself. Alternatively, the controller 170 may transmit the data points via the communications interface 180 to the interface 130 of the computer 34 and an external processor (not shown) may derive the signature.

The signature can then be sent for storage to the database 40, following which it can be accessed for comparison to a signature obtained by a subsequent validation scan to determine the authenticity of the article 62.

As well as using a predetermined print pattern to designate an area to generate a signature on an article 62, the same predetermined print pattern can also indicate to a user the area to be scanned in order to subsequently validate the signature of the article 62. Alternatively, a raster scan can be used to relocate the predetermined start pattern when doing the validation scan.

FIG. 5 is a block schematic diagram of functional components of the system 100. The printer motor 22 is connected to a microcontroller 30 through an electrical link 23. The detectors 16a and 16b of the detector module 16 are connected through respective electrical connection lines 17a and 17b to an analogue-to-digital converter (ADC) that is part of the microcontroller 30. A similar electrical connection line 21 connects the optional marker reading detector 19 to the microcontroller 30. It will be understood that optical or wireless links may be used instead of, or in combination with, electrical links. The microcontroller 30 is interfaced with the personal computer (PC) 34 through a data connection 120. The PC 34 may be a desktop or a laptop. As an alternative to a PC, other intelligent devices may be used, for example a personal digital assistant (PDA) or a dedicated electronics unit. The microcontroller 30 and PC 34 collectively form a data acquisition and processing module 36 for determining a signature of the article from the set of data points collected by the detectors 16a and 16b.

In some examples, the PC 34 can have access through an interface connection 140 to a database (dB) 40. The database 40 may be resident on the PC 34 in memory, or stored on a drive thereof. Alternatively, the database 40 may be remote from the PC 34 and accessed by wireless communication, for example using mobile telephony services or a wireless local area network (LAN) in combination with the internet. Moreover, the database 40 may be stored locally on the PC 34, but periodically downloaded from a remote source. The database may be administered by a remote entity, which entity may provide access to only a part of the total database to the particular PC 34, and/or may limit access the database on the basis of a security policy.

The database 40 can contain a library of previously recorded signatures. The PC 34 can be programmed so that in use it can access the database 40 and performs a comparison to establish whether the database 40 contains a match to the signature of the article that has been placed in the reading volume. The PC 34 can also be programmed to allow a signature to be added to the database if no match is found.

The way in which data flow between the PC and database is handled can be dependent upon the location of the PC and the relationship between the operator of the PC and the operator of the database. For example, if the PC and reader are being used to confirm the authenticity of an article, then the PC will not need to be able to add new articles to the database, and may in fact not directly access the database, but instead provide the signature to the database for comparison. In this arrangement the database may provide an authenticity result to the PC to indicate whether the article is authentic. On the other hand, if the PC and reader are being used to record or validate an item within the database, then the signature can be provided to the database for storage therein, and no comparison may be needed. In this situation a comparison could be performed however, to avoid a single item being entered into the database twice.

Thus there has now been described an example of a scanning and signature generation apparatus suitable for use in a security mechanism for remote verification of article authenticity. Such a system can be deployed to allow an article to be scanned in more than one location, and for a check to be performed to ensure that the article is the same article in both instances, and optionally for a check to performed to ensure that the article has not been tampered with between initial and subsequent scannings.

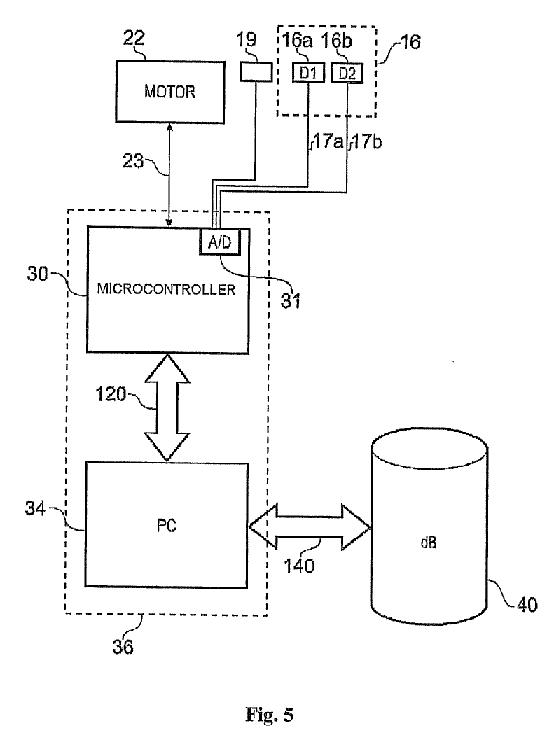

FIG. 6 is a schematic view of a reprographics device 110 incorporating a signature scanning unit 20. In this example, a housing 60 is provided, having an article feed tray 61 attached thereto. The tray 61 can hold one or more articles 62 for scanning by the reader. A motor can drive feed rollers 64 to carry an article 62 through the device and across a scanning aperture of an optics subassembly as described above. Thus the article 62 can be scanned by the optics subassembly in the manner discussed above in a manner whereby the relative motion between optics subassembly and article is created by movement of the article. Using such a system, the motion of the scanned item can be controlled using the motor with sufficient linearity that the use of distance marks and linearisation processing may be unnecessary. The apparatus could follow any conventional format for document scanners, photocopiers or document management systems. Such a scanner may be configured to handle line-feed sheets (where multiple sheets are connected together by, for example, a perforated join) as well as or instead of handing single sheets.

Thus there has now been described a reprographics device suitable for scanning articles in an automated feeder type device. Depending upon the physical arrangement of the feed arrangement, the scanner may be able to scan one or more single sheets of material, joined sheets or material or three-dimensional items such as packaging cartons.

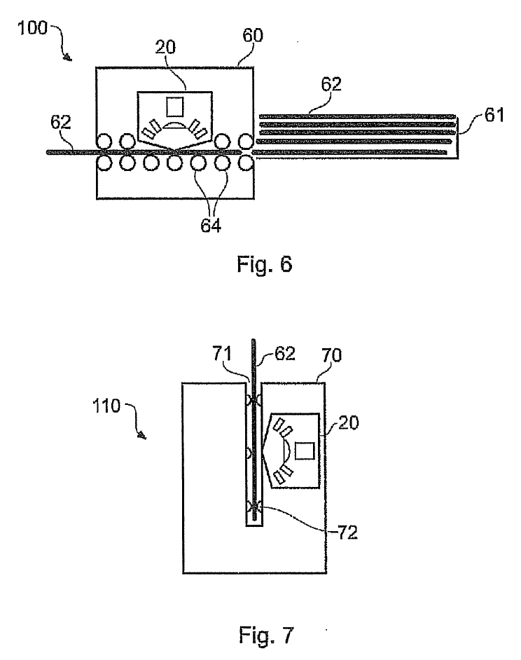

FIG. 7 shows another example of a schematic view of a reprographics device 110 incorporating a signature scanning unit 20. In this example, the article 62 is moved through the reader by a user. A housing 70 can be provided with a slot 71 therein for insertion of an article for scanning. An optics subassembly 20 can be provided with a scanning aperture directed into the slot 71 so as to be able to scan an article 62 passed through the slot. Additionally, guide elements 72 may be provided in the slot 71 to assist in guiding the article to the correct focal distance from the optics sub-assembly 20 and/or to provide for a constant speed passage of the article through the slot. A printing or embossing head (not shown) may also be incorporated in the housing 70 to provide reprographic functionality.

Reprographic scanners of this type may be particularly suited to making and/or scanning articles which are at least partially rigid, such as card, plastic or metal sheets. Such sheets may, for example, be plastic items such as credit cards or other bank cards.

Thus there have now been described an arrangement for manually initiated production/scanning of an article. This could be used for scanning bank cards and/or credit cards as they are made and/or subsequently. E.g. a card could be scanned at a terminal where that card is presented for use, and a signature taken from the card could be compared to a stored signature for the card to check the authenticity and un-tampered nature of the card. Such a device could also be used, for example in the context of reading a military-style embossed metal ID-tag (which tags are often also carried by allergy sufferers to alert others to their allergy). This could enable medical personnel treating a patient to ensure that the patient being treated was in fact the correct bearer of the tag. Likewise, in a casualty situation, a recovered tag could be scanned for authenticity to ensure that a casualty has been correctly identified before informing family and/or colleagues.

The above-described examples are based on localised excitation with a coherent light beam of small cross-section in combination with detectors that accept light signal scattered over a much larger area that includes the local area of excitation. It is possible to design a functionally equivalent optical system which is instead based on directional detectors that collect light only from localised areas in combination with excitation of a much larger area.

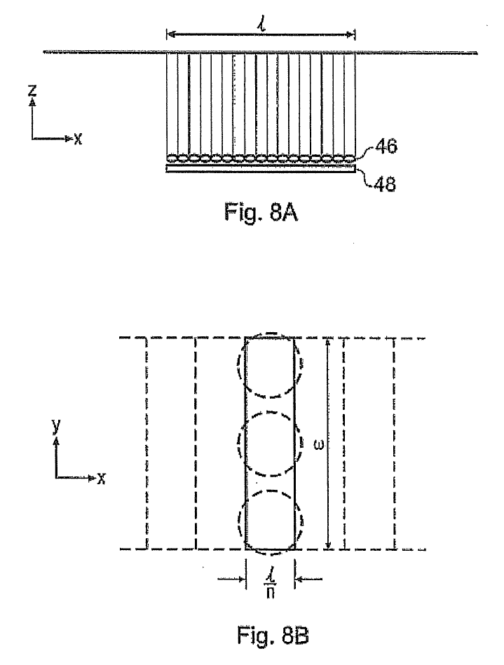

FIG. 8A shows schematically in side view such an imaging arrangement for a signature scanning unit which is based on directional light collection and blanket illumination with a coherent beam. An array detector 48 is arranged in combination with a cylindrical microlens array 46 so that adjacent strips of the detector array 48 only collect light from corresponding adjacent strips in the reading volume. With reference to FIG. 4, each cylindrical microlens is arranged to collect light signal from one of the n sampling strips. The coherent illumination can then take place with blanket illumination of the whole reading volume (not shown in the illustration).

A hybrid system with a combination of localised excitation and localised detection may also be useful in some cases.

FIG. 8B shows schematically in plan view the optical footprint of such a hybrid imaging arrangement for a signature scanning unit in which directional detectors are used in combination with localised illumination with an elongate beam. This example may be considered to be a development of the example of FIG. 3 in which directional detectors are provided. In this example three banks of directional detectors are provided, each bank being targeted to collect light from different portions along the ‘l×w’ excitation strip. The collection area from the plane of the reading volume are shown with the dotted circles, so that a first bank of, for example two, detectors collects light signal from the upper portion of the excitation strip, a second bank of detectors collects light signal from a middle portion of the excitation strip and a third bank of detectors collects light from a lower portion of the excitation strip. Each bank of detectors is shown having a circular collection area of diameter approximately l/m, where m is the number of subdivisions of the excitation strip, where m=3 in the present example. In this way the number of independent data points can be increased by a factor of m for a given scan length l. As described further below, one or more of different banks of directional detectors can be used for a purpose other than collecting light signal that samples a pattern. For example, one of the banks may be used to collect light signal in a way optimised for barcode scanning. If this is the case, it will generally be sufficient for that bank to contain only one detector, since there will be no advantage obtaining cross-correlations when only scanning for contrast.

Having now described the principal structural components and functional components of various removable cartridge apparatuses containing signature scanning units, the numerical processing used to determine a signature will now be described. It will be understood that this numerical processing can be implemented for the most part in a computer program that runs on the PC 34 with some elements subordinated to the microcontroller 30. In alternative examples, the numerical processing could be performed by a dedicated numerical processing device or devices in hardware or firmware, for example, provided in the removable cartridges themselves.

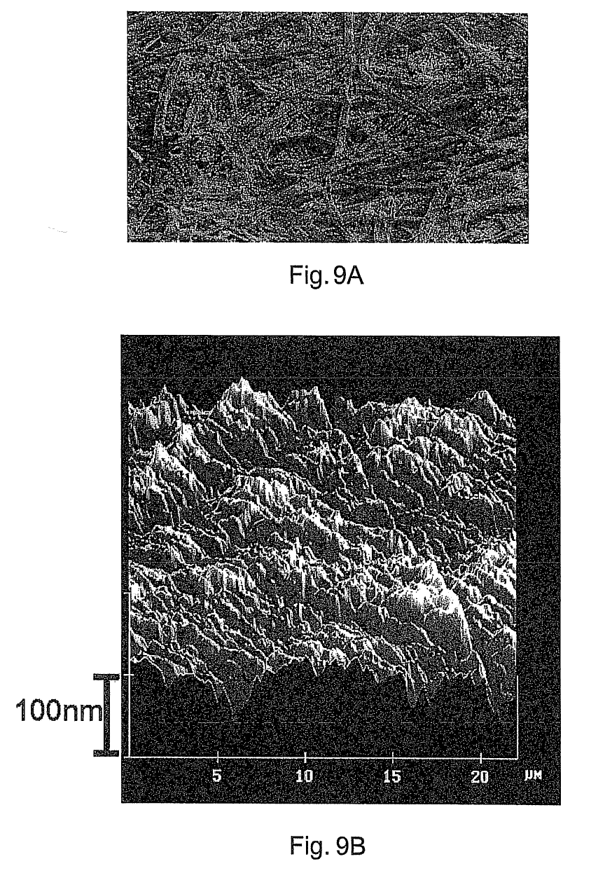

FIG. 9A is a microscope image of a paper surface with the image covering an area of approximately 0.5×0.2 mm. This figure is included to illustrate that macroscopically flat surfaces, such as from paper, are in many cases highly structured at a microscopic scale. For paper, the surface is microscopically highly structured as a result of the intermeshed network of wood or other fibres that make up the paper. The figure is also illustrative of the characteristic length scale for the wood fibres which is around 10 microns. This dimension has the correct relationship to the optical wavelength of the coherent beam of the present example to cause diffraction, and also diffuse scattering which has a profile that depends upon the fibre orientation. It will thus be appreciated that if a signature scanning unit is to be designed for a specific class of goods, the wavelength of the laser can be tailored to the structure feature size of the class of goods to be scanned. It is also evident from the figure that the local surface structure of each piece of paper will be unique in that it depends on how the individual wood fibres are arranged. A piece of paper is thus no different from a specially created token, such as the special resin tokens or magnetic material deposits of the prior art, in that it has structure which is unique as a result of it being made by a process governed by laws of nature. The same applies to many other types of article.

FIG. 9B shows an equivalent image for a plastic surface. This atomic force microscopy image clearly shows the uneven surface of the macroscopically smooth plastic surface. As can be surmised from the figure, this surface is smoother than the paper surface illustrated in FIG. 9A, but even this level of surface undulation can be uniquely identified using the signature generation scheme of the present example.

In other words, it can be essentially pointless to go to the effort and expense of making specially prepared tokens, when unique characteristics are measurable in a straightforward manner from a wide variety of every day articles. The data collection and numerical processing of a scatter signal that takes advantage of the natural structure of an article's surface (or interior in the case of transmission) is now described.

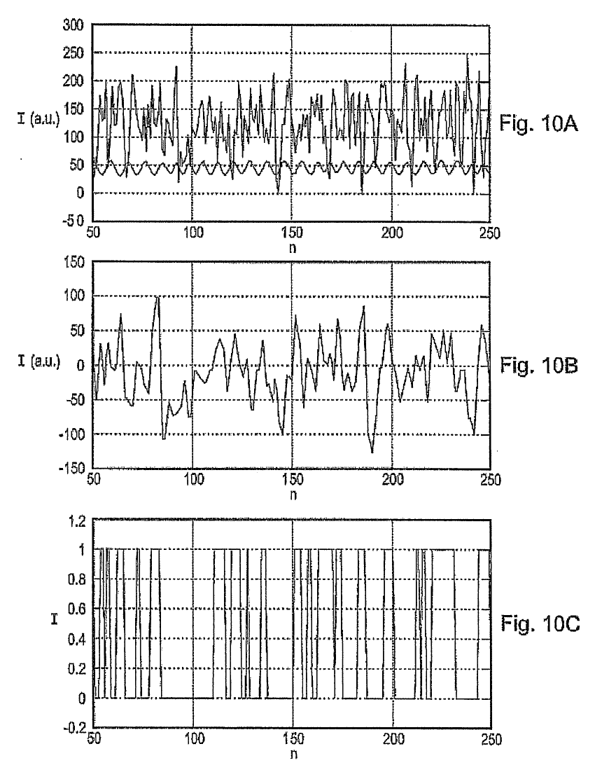

FIG. 10A shows raw data from a single one of the photodetectors 16a and 16b of the signature scanning unit of FIG. 3. The graph plots signal intensity I in arbitrary units (a.u.) against point number n (see FIG. 4). The higher trace fluctuating between I=0-250 is the raw signal data from photodetector 16a. The lower trace is the encoder signal picked up from the markers 28 (see FIG. 4) which is at around I=50.

FIG. 10B shows the photodetector data of FIG. 10A after linearisation with the encoder signal (n.b. although the x axis is on a different scale from FIG. 10A, this is of no significance). As noted above, where a movement of the article relative to the signature scanning unit is sufficiently linear, there may be no need to make use of a linearisation relative to alignment marks. In addition, the average of the intensity has been computed and subtracted from the intensity values. The processed data values thus fluctuate above and below zero.

FIG. 10C shows the data of FIG. 10B after digitisation. The digitisation scheme adopted is a simple binary one in which any positive intensity values are set at value 1 and any negative intensity values are set at zero. It will be appreciated that multi-state digitisation could be used instead, or any one of many other possible digitisation approaches. The main important feature of the digitisation is merely that the same digitisation scheme is applied consistently.

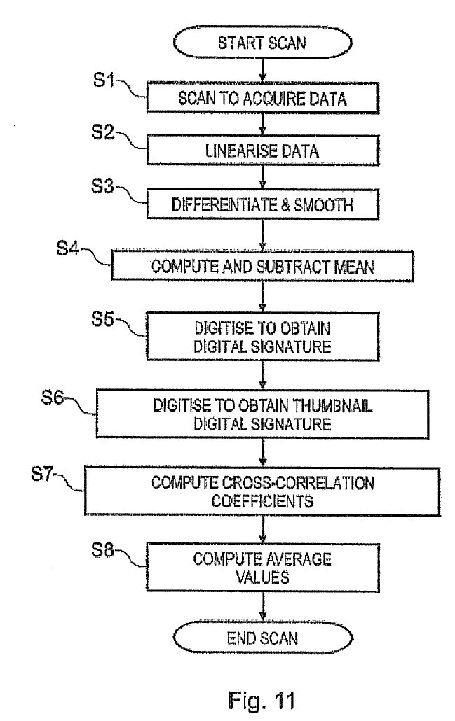

FIG. 11 is a flow diagram showing how a signature of an article is generated from a scan.

Step S1 is a data acquisition step during which the optical intensity at each of the photodetectors is acquired approximately every 1 ms during the entire length of scan. Simultaneously, the encoder signal is acquired as a function of time. It is noted that if the scan motor has a high degree of linearisation accuracy (e.g. as would a stepper motor/printer motor) then linearisation of the data may not be required. The data is acquired by the microcontroller 30 taking data from the ADC 31. The data points are transferred in real time from the microcontroller 30 to the PC 34. Alternatively, the data points could be stored in memory in the microcontroller 30 and then passed to the PC 34 at the end of a scan. The number n of data points per detector channel collected in each scan is defined as N in the following. Further, the value aₖ(i) is defined as the i-th stored intensity value from photodetector k, where i runs from 1 to N. Examples of two raw data sets obtained from such a scan are illustrated in FIG. 10A.

Step S2 uses numerical interpolation to locally expand and contract aₖ(i) so that the encoder transitions are evenly spaced in time. This corrects for local variations in the motor speed. This step can be performed in the PC 34 by a computer program.

Step S3 is an optional step. If performed, this step numerically differentiates the data with respect to time. It may also be desirable to apply a weak smoothing function to the data. Differentiation may be useful for highly structured surfaces, as it serves to attenuate uncorrelated contributions from the signal relative to correlated contributions.

Step S4 is a step in which, for each photodetector, the mean of the recorded signal is taken over the N data points. For each photodetector, this mean value is subtracted from all of the data points so that the data are distributed about zero intensity. Reference is made to FIG. 10B which shows an example of a scan data set after linearisation and subtraction of a computed average.

Step S5 digitises the analogue photodetector data to compute a digital signature representative of the scan. The digital signature is obtained by applying the rule: aₖ(i)>0 maps onto binary ‘1’ and aₖ(i)<=0 maps onto binary ‘0’. The digitised data set is defined as dₖ(i) where i runs from 1 to N. The signature of the article may incorporate further components in addition to the digitised signature of the intensity data just described. These further optional signature components are now described.

Step S6 is an optional step in which a smaller ‘thumbnail’ digital signature is created. This is done either by averaging together adjacent groups of m readings, or more preferably by picking every cth data point, where c is the compression factor of the thumbnail. The latter is preferred since averaging may disproportionately amplify noise. The same digitisation rule used in Step S5 is then applied to the reduced data set. The thumbnail digitisation is defined as tₖ(i) where i runs 1 to N/c and c is the compression factor.

Step S7 is an optional step applicable when multiple detector channels exist. The additional component is a cross-correlation component calculated between the intensity data obtained from different ones of the photodetectors. With 2 channels there is one possible cross-correlation coefficient, with 3 channels up to 3, and with 4 channels up to 6 etc. The cross-correlation coefficients are useful, since it has been found that they are good indicators of material type. For example, for a particular type of document, such as a passport of a given type, or laser printer paper, the cross-correlation coefficients always appear to lie in predictable ranges. A normalised cross-correlation can be calculated between aₖ(i) and aₗ(i), where k≠l and k,l vary across all of the photodetector channel numbers. The normalised cross-correlation function Γ is defined as

$$Γ ( k , l ) = \frac{{\sum }_{i = 1}^{n} {a}_{k} ( i ) {a}_{l} ( i )}{\sqrt{( {\sum }_{i = 1}^{N} {{a}_{k} ( i )}^{2} ) ( {\sum }_{i = 1}^{N} {{a}_{l} ( i )}^{2} )}}$$

Another aspect of the cross-correlation function that can be stored for use in later verification is the width of the peak in the cross-correlation function, for example the full width half maximum (FWHM). The use of the cross-correlation coefficients in verification processing is described further below.

Step S8 is another optional step which is to compute a simple intensity average value indicative of the signal intensity distribution. This may be an overall average of each of the mean values for the different detectors or an average for each detector, such as a root mean square (rms) value of aₖ(i). If the detectors are arranged in pairs either side of normal incidence as in the signature scanning unit described above, an average for each pair of detectors may be used. The intensity value has been found to be a good crude filter for material type, since it is a simple indication of overall reflectivity and roughness of the sample. For example, one can use as the intensity value the unnormalised rms value after removal of the average value, i.e. the DC background.

The signature data obtained from scanning an article can be compared against records held in a signature database for verification purposes and/or written to the database to add a new record of the signature to extend the existing database.

A new database record will include the digital signature obtained in Step S5. This can optionally be supplemented by one or more of its smaller thumbnail version obtained in Step S6 for each photodetector channel, the cross-correlation coefficients obtained in Step S7 and the average value(s) obtained in Step S8. Alternatively, the thumbnails may be stored on a separate database of their own optimised for rapid searching, and the rest of the data (including the thumbnails) on a main database.

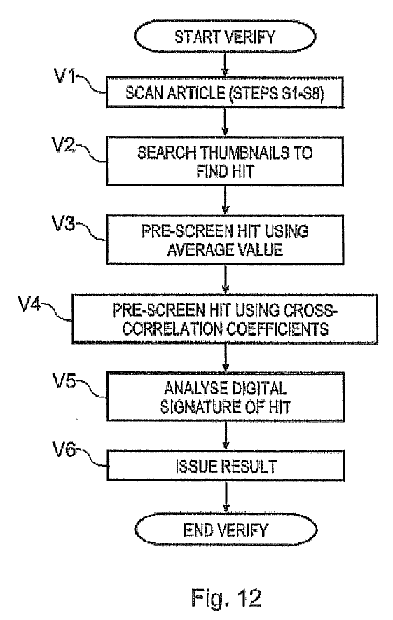

FIG. 12 is a flow diagram showing how a signature of an article obtained from a scan can be verified against a signature database.

In a simple implementation, the database could simply be searched to find a match based on the full set of signature data. However, to speed up the verification process, the process can use the smaller thumbnails and pre-screening based on the computed average values and cross-correlation coefficients as now described.

Verification Step V1 is the first step of the verification process, which is to scan an article according to the process described above, i.e. to perform Scan Steps S1 to S8.

Verification Step V2 takes each of the thumbnail entries and evaluates the number of matching bits between it and tₖ(i+j), where j is a bit offset which is varied to compensate for errors in placement of the scanned area. The value of j is determined and then the thumbnail entry which gives the maximum number of matching bits. This is the ‘hit’ used for further processing.

Verification Step V3 is an optional pre-screening test that is performed before analysing the full digital signature stored for the record against the scanned digital signature. In this pre-screen, the rms values obtained in Scan Step S8 are compared against the corresponding stored values in the database record of the hit. The ‘hit’ is rejected from further processing if the respective average values do not agree within a predefined range. The article is then rejected as non-verified (i.e. jump to Verification Step V6 and issue fail result).

Verification Step V4 is a further optional pre-screening test that is performed before analysing the full digital signature. In this pre-screen, the cross-correlation coefficients obtained in Scan Step S7 are compared against the corresponding stored values in the database record of the hit. The ‘hit’ is rejected from further processing if the respective cross-correlation coefficients do not agree within a predefined range. The article is then rejected as non-verified (i.e. jump to Verification Step V6 and issue fail result).

Another check using the cross-correlation coefficients that could be performed in Verification Step V4 is to check the width of the peak in the cross-correlation function, where the cross-correlation function is evaluated by comparing the value stored from the original scan in Scan Step S7 above and the re-scanned value:

$${Γ}_{k , l} ( j ) = \frac{{\sum }_{i = 1}^{n} {a}_{k} ( i ) {a}_{l} ( i + j )}{\sqrt{( {\sum }_{i = 1}^{N} {{a}_{k} ( i )}^{2} ) ( {\sum }_{i = 1}^{N} {{a}_{l} ( i )}^{2} )}}$$

If the width of the re-scanned peak is significantly higher than the width of the original scan, this may be taken as an indicator that the re-scanned article has been tampered with or is otherwise suspicious. For example, this check should beat a fraudster who attempts to fool the system by printing a bar code or other pattern with the same intensity variations that are expected by the photodetectors from the surface being scanned.

Verification Step V5 is the main comparison between the scanned digital signature obtained in Scan Step S5 and the corresponding stored values in the database record of the hit. The full stored digitised signature, dₖ^{db}(i) is split into n blocks of q adjacent bits on k detector channels, i.e. there are qₖ bits per block. A typical value for q is 4 and a typical value for k is 4, making typically 16 bits per block. The qk bits are then matched against the qk corresponding bits in the stored digital signature dₖ^{db}(i+j). If the number of matching bits within the block is greater or equal to some pre-defined threshold zₜₕᵣₑₛₕ, then the number of matching blocks is incremented. A typical value for zₜₕᵣₑₛₕ is 13. This is repeated for all n blocks. This whole process is repeated for different offset values of j, to compensate for errors in placement of the scanned area, until a maximum number of matching blocks is found. Defining M as the maximum number of matching blocks, the probability of an accidental match is calculated by evaluating:

$$p ( M ) = {\sum }_{w = n - M}^{n} {{s}^{w} ( 1 - s )}^{n - w} {}_{w}^{n} C$$

where s is the probability of an accidental match between any two blocks (which in turn depends upon the chosen value of z_{threshold}), M is the number of matching blocks and p(M) is the probability of M or more blocks matching accidentally. The value of s is determined by comparing blocks within the data base from scans of different objects of similar materials, e.g. a number of scans of paper documents etc. For the case of q=4, k=2 and z_{threshold}=7, we typical value of s is 0.1. If the qk bits were entirely independent, then probability theory would give s=0.01 for z_{threshold}=7. The fact that a higher value is found empirically is because of correlations between the k detector channels and also correlations between adjacent bits in the block due to a finite laser spot width. A typical scan of a piece of paper yields around 314 matching blocks out of a total number of 510 blocks, when compared against the data base entry for that piece of paper. Setting M=314, n=510, s=0.1 for the above equation gives a probability of an accidental match of 10⁻¹⁷⁷.

Verification Step V6 issues a result of the verification process. The probability result obtained in Verification Step V5 may be used in a pass/fail test in which the benchmark is a pre-defined probability threshold. In this case the probability threshold may be set at a level by the system, or may be a variable parameter set at a level chosen by the user. Alternatively, the probability result may be output to the user as a confidence level, either in raw form as the probability itself, or in a modified form using relative terms (e.g. no match/poor match/good match/excellent match) or other classification.

It will be appreciated that many variations are possible. For example, instead of treating the cross-correlation coefficients as a pre-screen component, they could be treated together with the digitised intensity data as part of the main signature. For example the cross-correlation coefficients could be digitised and added to the digitised intensity data. The cross-correlation coefficients could also be digitised on their own and used to generate bit strings or the like which could then be searched in the same way as described above for the thumbnails of the digitised intensity data in order to find the hits.

Thus there have now been described a number of examples arrangements for scanning an article to obtain a signature based upon intrinsic properties of that article. There have also been described examples of how that signature can be generated from the data collected during the scan, and how the signature can be compared to a later scan from the same or a different article to provide a measure of how likely it is that the same article has been scanned in the later scan.

Such a system has many applications, amongst which are security and confidence screening of items for fraud prevention and item traceability.

In some examples, the method for extracting a signature from a scanned article can be optimised to provide reliable recognition of an article despite deformations to that article caused by, for example, stretching or shrinkage. Such stretching or shrinkage of an article may be caused by, for example, water damage to a paper or cardboard based article.

Also, an article may appear to a scanner comprising a signature scanning unit to be stretched or shrunk if the relative speed of the article to the sensors in the scanner is non-linear. This may occur if, for example the article is being moved along a conveyor system, or if the article is being moved through a scanner by a human holding the article. An example of a likely scenario for this to occur is where a human scans, for example, a bank card using a scanner such as that described with reference to FIG. 7 above.

As described above, where a scanner is based upon a scan head which moves within the scanner unit relative to an article held stationary against or in the scanner, then linearisation guidance can be provided by the optional distance marks 28 to address any non-linearities in the motion of the scan head. Where the article is moved by a human, these non-linearities can be greatly exaggerated

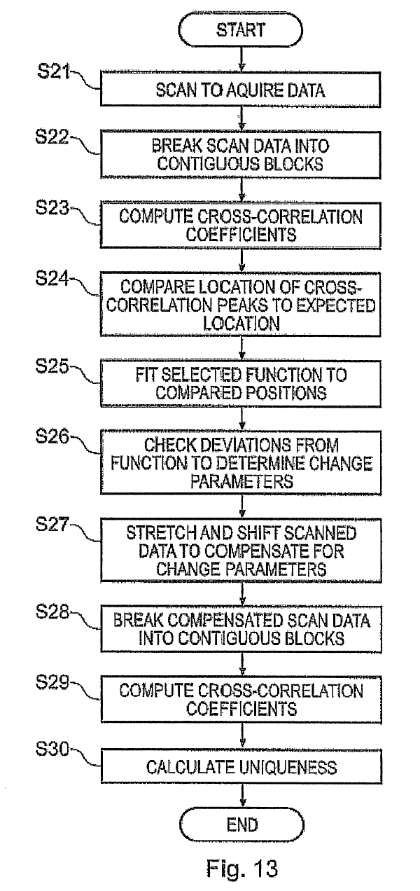

To address recognition problems which could be caused by these non-linear effects, it is possible to adjust the analysis phase of a scan of an article. Thus a modified validation procedure will now be described with reference to FIG. 13. The process implemented in this example uses a block-wise analysis of the data to address the non-linearities.

The process carried out in accordance with FIG. 13, can include some or all of the steps of smoothing and differentiating the data, computing and subtracting the mean, and digitisation for obtaining the signature and thumbnail described with reference to FIG. 11, but are not shown in FIG. 13 so as not to obscure the content of that figure.

As shown in FIG. 13, the scanning process for a validation scan using a block-wise analysis starts at step S21 by performing a scan of the article to acquire the data describing the intrinsic properties of the article. This scanned data is then divided into contiguous blocks (which can be performed before or after digitisation and any smoothing/differentiation or the like) at step S22. In one example, a scan length of 64 mm is divided into eight equal length blocks. Each block therefore represents a subsection of scanned area of the scanned article.

For each of the blocks, a cross-correlation is performed against the equivalent block for each stored signature with which it is intended that article be compared at step S23. This can be performed using a thumbnail approach with one thumbnail for each block. The results of these cross-correlation calculations are then analysed to identify the location of the cross-correlation peak. The location of the cross-correlation peak is then compared at step S24 to the expected location of the peak for the case were a perfectly linear relationship to exist between the original and later scans of the article.

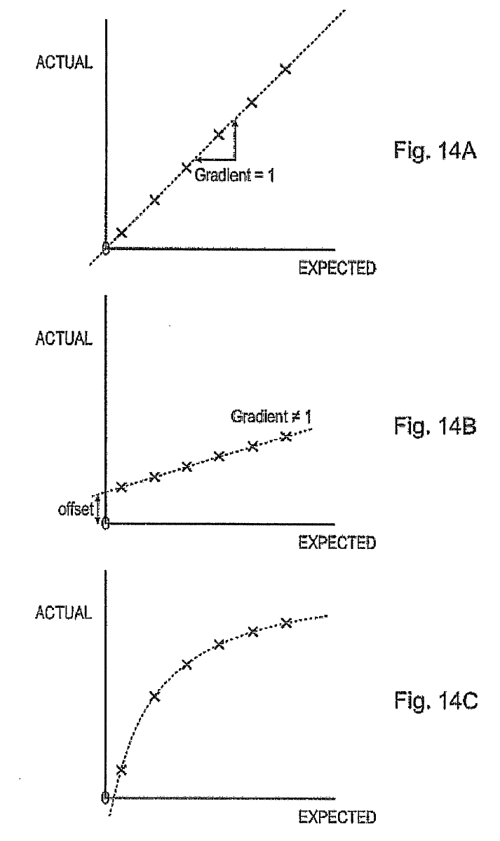

This relationship can be represented graphically as shown in FIGS. 14A, 14B and 14C. In the example of FIG. 14A, the cross-correlation peaks are exactly where expected, such that the motion of the scan head relative to the article has been perfectly linear and the article has not experienced stretch or shrinkage. Thus a plot of actual peak positions against expected peak results in a straight line which passes through the origin and has a gradient of 1.

In the example of FIG. 14B, the cross-correlation peaks are closer together than expected, such that the gradient of a line of best fit is less than one. Thus the article has shrunk relative to its physical characteristics upon initial scanning. Also, the best fit line does not pass through the origin of the plot. Thus the article is shifted relative to the scan head compared to its position upon initial scanning.

In the example of FIG. 14C, the cross correlation peaks do not form a straight line. In this example, they approximately fit to a curve representing a y function. Thus the movement of the article relative to the scan head has slowed during the scan. Also, as the best fit curve does not cross the origin, it is clear that the article is shifted relative to its position upon initial scanning.

A variety of functions can be test-fitted to the plot of points of the cross-correlation peaks to find a best-fitting function. Thus curves to account for stretch, shrinkage, misalignment, acceleration, deceleration, and combinations thereof can be used. Examples of suitable functions can include straight line functions, exponential functions, a trigonometric functions, x² functions and x³ functions.

Once a best-fitting function has been identified at step S25, a set of change parameters can be determined which represent how much each cross-correlation peak is shifted from its expected position at step S26. These compensation parameters can then, at step S27, be applied to the data from the scan taken at step S21 in order substantially to reverse the effects of the shrinkage, stretch, misalignment, acceleration or deceleration on the data from the scan. As will be appreciated, the better the best-fit function obtained at step S25 fits the scan data, the better the compensation effect will be.

The compensated scan data is then broken into contiguous blocks at step S28 as in step S22. The blocks are then individually cross-correlated with the respective blocks of data from the stored signature at step S29 to obtain the cross-correlation coefficients. This time the magnitude of the cross-correlation peaks are analysed to determine the uniqueness factor at step S29. Thus it can be determined whether the scanned article is the same as the article which was scanned when the stored signature was created.

Accordingly, there has now been described an example of a method for compensating for physical deformations in a scanned article, and for non-linearities in the motion of the article relative to the scanner. Using this method, a scanned article can be checked against a stored signature for that article obtained from an earlier scan of the article to determine with a high level of certainty whether or not the same article is present at the later scan. Thereby an article constructed from easily distorted material can be reliably recognised. Also, a scanner where the motion of the scanner relative to the article may be non-linear can be used, thereby allowing the use of a low-cost scanner without motion control elements.

Another characteristic of an article which can be detected using a block-wise analysis of a signature generated based upon an intrinsic property of that article is that of localised damage to the article. For example, such a technique can be used to detect modifications to an article made after an initial record scan.

For example, many documents, such as passports, ID cards and driving licenses, include photographs of the bearer. If an authenticity scan of such an article includes a portion of the photograph, then any alteration made to that photograph will be detected. Taking an arbitrary example of splitting a signature into 10 blocks, three of those blocks may cover a photograph on a document and the other seven cover another part of the document, such as a background material. If the photograph is replaced, then a subsequent rescan of the document can be expected to provide a good match for the seven blocks where no modification has occurred, but the replaced photograph will provide a very poor match. By knowing that those three blocks correspond to the photograph, the fact that all three provide a very poor match can be used to automatically fail the validation of the document, regardless of the average score over the whole signature.

Also, many documents include written indications of one or more persons, for example the name of a person identified by a passport, driving license or identity card, or the name of a bank account holder. Many documents also include a place where written signature of a bearer or certifier is applied. Using a block-wise analysis of a signature obtained therefrom for validation can detect a modification to alter a name or other important word or number printed or written onto a document. A block which corresponds to the position of an altered printing or writing can be expected to produce a much lower quality match than blocks where no modification has taken place. Thus a modified name or written signature can be detected and the document failed in a validation test even if the overall match of the document is sufficiently high to obtain a pass result.

The area and elements selected for the scan area can depend upon a number of factors, including the element of the document which it is most likely that a fraudster would attempt to alter. For example, for any document including a photograph the most likely alteration target will usually be the photograph as this visually identifies the bearer. Thus a scan area for such a document might beneficially be selected to include a portion of the photograph. Another element which may be subjected to fraudulent modification is the bearer's signature, as it is easy for a person to pretend to have a name other than their own, but harder to copy another person's signature. Therefore for signed documents, particularly those not including a photograph, a scan area may beneficially include a portion of a signature on the document.

In the general case therefore, it can be seen that a test for authenticity of an article can comprise a test for a sufficiently high quality match between a verification signature and a record signature for the whole of the signature, and a sufficiently high match over at least selected blocks of the signatures. Thus regions important to the assessing the authenticity of an article can be selected as being critical to achieving a positive authenticity result.

In some examples, blocks other than those selected as critical blocks may be allowed to present a poor match result. Thus a document may be accepted as authentic despite being torn or otherwise damaged in parts, so long as the critical blocks provide a good match and the signature as a whole provides a good match.

Thus there have now been described a number of examples of a system, method and apparatus for identifying localised damage to an article, and for rejecting an inauthentic an article with localised damage or alteration in predetermined regions thereof. Damage or alteration in other regions may be ignored, thereby allowing the document to be recognised as authentic.

In some scanner apparatuses, it is also possible that it may be difficult to determine where a scanned region starts and finishes. One approach to addressing this difficulty would be to define the scan area as starting at the edge of the article. As the data received at the scan head will undergo a clear step change when an article is passed though what was previously free space, the data retrieved at the scan head can be used to determine where the scan starts.

In this example, the scan head is operational prior to the application of the article to the scanner. Thus initially the scan head receives data corresponding to the unoccupied space in front of the scan head. As the article is passed in front of the scan head, the data received by the scan head immediately changes to be data describing the article. Thus the data can be monitored to determine where the article starts and all data prior to that can be discarded. The position and length of the scan area relative to the article leading edge can be determined in a number of ways. The simplest is to make the scan area the entire length of the article, such that the end can be detected by the scan head again picking up data corresponding to free space. Another method is to start and/or stop the recorded data a predetermined number of scan readings from the leading edge. Assuming that the article always moves past the scan head at approximately the same speed, this would result in a consistent scan area. Another alternative is to use actual marks on the article to start and stop the scan region, although this may require more work, in terms of data processing, to determine which captured data corresponds to the scan area and which data can be discarded.

Thus there have now been described a number of techniques for scanning an item to gather data based on an intrinsic property of the article, compensating if necessary for damage to the article or non-linearities in the scanning process, and comparing the article to a stored signature based upon a previous scan of an article to determine whether the same article is present for both scans.

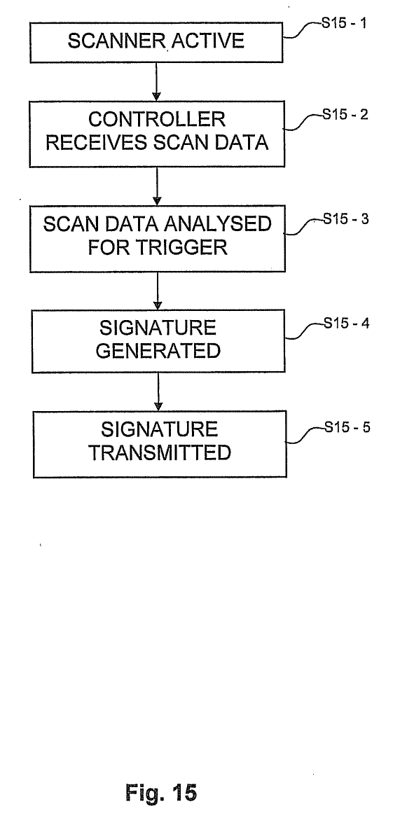

FIG. 15 shows how the scanning unit 20 and controller 170 may interact with each other to collect a set of data points which can be used to generate a signature for an article.

In use, an article 62 is inserted into the printer. The article 62 may have pre-printed patterns already applied to it, such as indicia or symbols shown in FIG. 4A, or the article 62 may have printed matter applied to it by a print cartridge during the collection of the data points for the signature generation.

A removable cartridge 12, as defined above, is inserted into a spare print cartridge holder in the printer, such as a colour cartridge holder. Another print cartridge, for example a black print cartridge, can remain in its usual cartridge holder to perform any printing on the article which may be desired. When a print cartridge and removable cartridge 12 are arranged this way, the print head of the print cartridge may move along its designated linear path to print indicia or symbols on and article, whilst the scanning unit 20 may scan of the portion of the article in the reading volume 10 of the scanning unit 20.

When the printing phase begins, the scanning unit 20 may also begin scanning the surface of the article 62, as shown at step S15-1 of FIG. 15. The scanning unit 20 feeds data which represents the detail of the indicia or symbols and the intrinsic characteristics of the article to the controller, as shown at step S15-2.

The controller 170 is programmed to operate in a watch mode and/or a data collection mode. At the beginning of the scanning process, the controller 170 is in the watch mode. During this stage, the controller 170 is receiving data from the scanning unit 20 and watching for data representing a predetermined pattern, which may consist of indicia and/or symbols such as those shown in FIG. 4A. Once this pattern is recognised, this triggers the controller 170 to switch to its data collection mode. During this stage, the controller 170 collects data points representing the intrinsic properties of the article 62 in the volume reader 10 from the scanning unit 20, as shown at step S15-3. Step S15-4 shows the process of forwarding the collected data points to a processor, either internal or external to the removable cartridge 12, to generate a signature. The steps which may be followed to process the data points and generate the signature are detailed in steps S1 to S8 of FIG. 11, or steps S21 to S30 of FIG. 13, and in the corresponding section of the description above.

The processing of the data points continues until the controller 170 switches back to its watch mode and ceases collecting data points. A variety of triggers may be used to achieve this effect.

In one embodiment, a predetermined time may be used to trigger the controller to cease collecting data points.

In an alternative embodiment the linear speed at which the print cartridge carrier moves across the article may be used to determine a predetermined distance from the start point of the collection of the data points. Once the predetermined distance has been reached, this triggers the controller to cease collecting data points.

In a further alternative embodiment, the controller 170 may continue operating in its watch mode at the same time its data collection mode begins. In this arrangement, the controller 170 may continue receiving information from the scanner unit 20 which represents the details of the indicia or symbols appearing on the surface of the article 62 whilst the controller also collects data points representing the intrinsic properties of the article. In this embodiment, the trigger for the controller to cease collecting data points may occur when the controller recognises a predetermined stop pattern. Once the controller receives information from the scanning unit that that the predetermined stop pattern on the article has been scanned, this triggers the controller to cease collecting data points representing the intrinsic characteristics of the article and the controller 170 may continue on in its watch mode only. Such a stop pattern may be the same as or different to the start pattern.

At the end of the data point collection and signature generation phase, the signature can be transmitted to an external database for storage, as shown at step S15-5 of FIG. 15. This signature can then be used to compare it with a subsequent verification signatures in order to authenticate an article. The verification process used may be that shown in FIG. 12 and described in the corresponding section of the description above.

Thus there has now been described a system for beginning and ceasing the collecting data points for generating a unique signature of an article, which may be subsequently used in order to verify the authenticity of that article.

In various embodiments, the signature scanning unit uses four single channel detectors (four simple phototransistors) which are angularly spaced apart to collect only four signal components from the scattered laser beam. The laser beam is focused to a spot covering only a very small part of the surface. Signal is collected from different localised areas on the surface by the four single channel detectors as the spot is scanned over the surface. The characteristic response from the article is thus made up of independent measurements from a large number (typically hundreds or thousands) of different localised areas on the article surface. Although four phototransistors are used, analysis using only data from a single one of the phototransistors shows that a unique characteristic response can be derived from this single channel alone. However, higher security levels are obtained if further ones of the four channels are included in the response.

In various embodiments, it can be ensured that different ones of the data points relate to scatter from different parts of the article, in that the detector arrangement includes a plurality of detector channels arranged and configured to sense scatter from respective different parts of the article. This can be achieved with directional detectors, local collection of signal with optical fibres or other measures. With directional detectors or other localised collection of signal, the coherent beam does not need to be focused. Indeed, the coherent beam could be static and illuminate the whole sampling volume. Directional detectors could be implemented by focusing lenses fused to, or otherwise fixed in relation to, the detector elements. Optical fibres may be used in conjunction with microlenses.

It is possible to make a workable reader when the detector arrangement consists of only a single detector channel. Other embodiments use a detector arrangement that comprises a group of detector elements angularly distributed and operable to collect a group of data points for each different part of the reading volume, preferably a small group of a few detector elements. Security enhancement is provided when the signature incorporates a contribution from a comparison between data points of the same group. This comparison may conveniently involve a cross-correlation.

Although a working reader can be made with only one detector channel, there are preferably at least 2 channels. This allows cross-correlations between the detector signals to be made, which is useful for the signal processing associated with determining the signature. It is envisaged that between 2 and 10 detector channels will be suitable for most applications with 2 to 4 currently being considered as the optimum balance between apparatus simplicity and security.

The detector elements are advantageously arranged to lie in a plane intersecting the reading volume with each member of the pair being angularly distributed in the plane in relation to the coherent beam axis, preferably with one or more detector elements either side of the beam axis. However, non-planar detector arrangements are also acceptable.

The use of cross-correlations of the signals obtained from the different detectors has been found to give valuable data for increasing the security levels and also for allowing the signatures to be more reliably reproducible over time. The utility of the cross-correlations is somewhat surprising from a scientific point of view, since speckle patterns are inherently uncorrelated (with the exception of signals from opposed points in the pattern). In other words, for a speckle pattern there will by definition be zero cross-correlation between the signals from the different detectors so long as they are not arranged at equal magnitude angles offset from the excitation location in a common plane intersecting the excitation location. The value of using cross-correlation contributions therefore indicates that an important part of the scatter signal is not speckle. The non-speckle contribution could be viewed as being the result of direct scatter, or a diffuse scattering contribution, from a complex surface, such as paper fibre twists. At present the relative importance of the speckle and non-speckle scatter signal contribution is not clear. However, it is clear from the experiments performed to date that the detectors are not measuring a pure speckle pattern, but a composite signal with speckle and non-speckle components.

Incorporating a cross-correlation component in the signature can also be of benefit for improving security. This is because, even if it is possible using high resolution printing to make an article that reproduces the contrast variations over the surface of the genuine article, this would not be able to match the cross-correlation coefficients obtained by scanning the genuine article.

In the one embodiment, the detector channels are made up of discrete detector components in the form of simple phototransistors. Other simple discrete components could be used such as PIN diodes or photodiodes. Integrated detector components, such as a detector array could also be used, although this would add to the cost and complexity of the device.

From initial experiments which modify the illumination angle of the laser beam on the article to be scanned, it also seems to be preferable in practice that the laser beam is incident approximately normal to the surface being scanned in order to obtain a characteristic that can be repeatedly measured from the same surface with little change, even when the article is degraded between measurements. At least some known readers use oblique incidence (see GB 2 221 870). Once appreciated, this effect seems obvious, but it is clearly not immediately apparent as evidenced by the design of some prior art readers including that of GB 2 221 870 and indeed the first prototype reader built by the inventor. The inventor's first prototype reader with oblique incidence functioned reasonably well in laboratory conditions, but was quite sensitive to degradation of the paper used as the article. For example, rubbing the paper with fingers was sufficient to cause significant differences to appear upon re-measurement. The second prototype reader used normal incidence and has been found to be robust against degradation of paper by routine handling, and also more severe events such as: passing through various types of printer including a laser printer, passing through a photocopier machine, writing on, printing on, deliberate scorching in an oven, and crushing and re-flattening.

It can therefore be advantageous to mount the source so as to direct the coherent beam onto the reading volume so that it will strike an article with near normal incidence. By near normal incidence means±5, 10 or 20 degrees. Alternatively, the beam can be directed to have oblique incidence on the articles. This will usually have a negative influence in the case that the beam is scanned over the article.

It is also noted that in the signature scanning units described in the detailed description, the detector arrangement is arranged in reflection to detect radiation back scattered from the reading volume. However, if the article is transparent, the detectors could be arranged in transmission.

A system for identifying an article from a signature can be operable to access a database of previously recorded signatures and perform a comparison to establish whether the database contains a match to the signature of an article that has been placed in the reading volume. The database may be part of a mass storage device that forms part of a computer system, or may be at a remote location and accessed by the reader through a telecommunications link. The telecommunications link may take any conventional form, including wireless and fixed links, and may be available over the Internet. The data acquisition and processing module may be operable, at least in some operational modes, to allow the signature to be added to the database if no match is found.

When using a database, in addition to storing the signature it may also be useful to associate that signature in the database with other information about the article such as a scanned copy of the document, a photograph of a passport holder, details on the place and time of manufacture of the product, or details on the intended sales destination of vendable goods (e.g. to track grey importation).

The invention allows identification of articles made of a variety of different kinds of materials, such as paper, cardboard and plastic, for example.

By intrinsic structure we mean structure that the article inherently will have by virtue of its manufacture, thereby distinguishing over structure specifically provided for security purposes, such as structure given by tokens or artificial fibres incorporated in the article.

By paper or cardboard we mean any article made from wood pulp or equivalent fibre process. The paper or cardboard may be treated with coatings or impregnations or covered with transparent material, such as cellophane. If long-term stability of the surface is a particular concern, the paper may be treated with an acrylic spray-on transparent coating, for example.

Data points can thus be collected as a function of position of illumination by the coherent beam. This can be achieved either by scanning a localised coherent beam over the article, or by using directional detectors to collect scattered light from different parts of the article, or by a combination of both.

The signature is envisaged to be a digital signature in most applications. Typical sizes of the digital signature with current technology would be in the range 200 bits to 8 k bits, where currently it is preferable to have a digital signature size of about 2 k bits for high security.

Although the embodiments above have been described in considerable detail, numerous variations and modifications will become apparent to those skilled in the art once the above disclosure is fully appreciated. It is intended that the following claims be interpreted to embrace all such variations and modifications as well as their equivalents.

1. A removable cartridge for a reprographics device, the removable cartridge comprising:
a scanning unit operable to obtain a set of data points conveying information describing an intrinsic structure characteristic of an article; and
a controller operable to control said scanning unit to start obtaining the set of data points in response to detection of a predetermined printed pattern on an article.

2. A removable cartridge according to claim 1 wherein said controller is operable to control said scanning unit to stop obtaining data points after a predetermined time.

3. A removable cartridge according to claim 1 wherein said controller is operable to control said scanning unit to stop obtaining data points after a predetermined distance.

4. A removable cartridge according to claim 1 wherein said controller is operable to control said scanning unit to stop obtaining data points in response to detection of a predetermined printed stop pattern.

5. A removable cartridge according to claim 1 wherein the scanning unit is operable to collect a set of data points from an article in a reading volume of the scanning unit, the scanning unit comprising:
a source for generating a coherent beam; and
a detector arrangement for collecting a set comprising groups of said data points from signals obtained when the coherent beam scatters from different parts of an article in the reading volume, wherein different ones of the groups of data points relate to scatter from respective different parts of the article.

6. A removable cartridge according claim 1 wherein said controller includes a processor for processing said data points to generate a signature.

7. A removable cartridge according to claim 6 including a communications interface for transmitting said signature from said controller to a database.

8. A removable cartridge according to claim 1 including a communications interface for transmitting data points from said controller to an external processor for generating said signature.

9. A removable cartridge according to claim 8 wherein said external processor is operable to transmit said signature to a database.

10. A removable cartridge according to claim 7, wherein said communications interface sends information via a wireless communication system.

11. A removable cartridge according to claim 1 wherein said cartridge is powered by batteries.

12. A removable cartridge according to claim 1 wherein said cartridge is powered by the printer interface of a reprographics device into which it is removably received.

13. A system for generating a signature wherein said system includes:
a removable cartridge comprising: a scanning unit operable to obtain a set of data points conveying information describing an intrinsic structure characteristic of an article; a controller operable to control said scanning unit to start obtaining the set of data points in response to detection of a predetermined printed pattern on an article and to process said data points to generate a signature; and a communications interface for transmitting said signature from said controller to a database; and
a database for receiving said signature from said communications interface.

14. A system according to claim 13, wherein said communications interface sends information via a wireless communication system.

15. A system for generating a signature wherein said system includes:
a removable cartridge comprising a scanning unit operable to obtain a set of data points conveying information describing an intrinsic structure characteristic of an article; a controller operable to control said scanning unit to start obtaining the set of data points in response to detection of a predetermined printed pattern on an article; and a communications interface for transmitting data points from said controller to an external processor for generating said signature;
an external processor for receiving data points from said communications interface, said processor being operable to generate said signature; and
a database for receiving said signature from said external processor.

16. A system according to claim 15, wherein said communications interface sends information via a wireless communication system.

17. A removable cartridge for a reprographics device, the removable cartridge comprising:
means for obtaining a set of data points conveying information describing an intrinsic structure characteristic of an article; and
means for controlling said means for obtaining a set of data points to start obtaining the set of data points in response to detection of a predetermined printed pattern on an article.

18. A method for triggering collection of data points conveying information describing an intrinsic structure characteristic of an article, said method comprising:
detecting a predetermined start pattern on an article received in a reading volume of a scanning unit and starting collection of said data points in response to detection of said pattern.

19. A method according to claim 18 wherein said controller stops collecting data points from said scanning unit after a predetermined time.

20. A method according to claim 18 wherein said controller stops collecting data points from said scanning unit after a predetermined distance.

21. A method according to claim 18 wherein said controller stops collecting data points from said scanning unit in response to detecting a predetermined stop pattern.

22. A method according to claim 18 wherein said predetermined start pattern is selected from the group consisting of at least two or more vertical lines in parallel, a predetermined text pattern, or a logo.

23. A method according to claim 21 wherein said predetermined stop pattern is selected from the group consisting of at least two or more vertical lines in parallel, a predetermined text pattern, a logo, or a blank space.

24. A method according to claim 17 wherein collection of said data points includes the steps of:
generating a coherent beam;
directing said coherent beam into said reading volume; and
collecting signals created by scatter of said coherent beam within said reading volume, wherein different ones of said signals relate to scatter from different parts of said reading volume.
